(19) United States
(12) Patent Application Publication
(10) Pub. No.: US 2014/0122525 A1
(43) Pub. Date: May 1, 2014

(54) APPLICATION COLLABORATION PLATFORM AND APPLICATION COLLABORATION METHOD

(71) Applicant: HON HAI PRECISION INDUSTRY CO., LTD., New Taipei (TW)

(72) Inventors: BIN-RONG CHEN, New Taipei (TW); CHIH-YUAN HUANG, New Taipei (TW)

(73) Assignee: HON HAI PRECISION INDUSTRY CO., LTD., New Taipei (TW)

(21) Appl. No.: 14/040,484

(22) Filed: Sep. 27, 2013

(30) Foreign Application Priority Data
Oct. 31, 2012 (TW) 101140223

(51) Int. Cl. G06F 17/30

(52) U.S. Cl. CPC G06F 17/30424
USPC 707/769

(57) ABSTRACT

An application collaboration (AC) platform is used to realize application collaboration between two user devices. The AC platform includes a semantic database which stores semantic descriptions of a plurality of user devices. When a semantic query message is received from a request devices, one or more of the user devices which match the semantic query message are searched and one of the searched user devices is selected as a target device. Data for application collaboration is exchanged between the request device and the target device. The target device performs the application collaboration according to the data and generates result data after performing the application collaboration. The result data is transmitted to the request device to accomplish the application collaboration between the request device and the target device.

### BACKGROUND

1. Technical Field

Embodiments of the present disclosure relate to collaborative operation of software applications, and particularly to an application collaboration platform and method.

2. Description of Related Art

Collaboration in the operation of a software application is called application collaboration (AC). Application collaboration is becoming more important. There are many situations where different users need to collaborate and work together on a software application. For example, different players from different places may collaborate to play a game and complete a task. However, many applications do not support application collaboration. Thus, different devices which have the same applications, which do not support application collaboration, cannot collaborate with each other to cooperatively accomplish a same task. Therefore, there is room for improvement in the art.

### BRIEF DESCRIPTION OF THE DRAWINGS

FIG. 1 is a schematic diagram illustrating one embodiment of an application collaboration (AC) platform communicating with a plurality of user devices.

FIG. 2 is a schematic block diagram of the AC platform of FIG. 1 including a plurality of functional modules.

FIG. 3 is a flowchart of one embodiment of an application collaboration method implemented by the AC platform of FIG. 1.

FIG. 4 is a schematic diagram illustrating semantic descriptions of a user device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

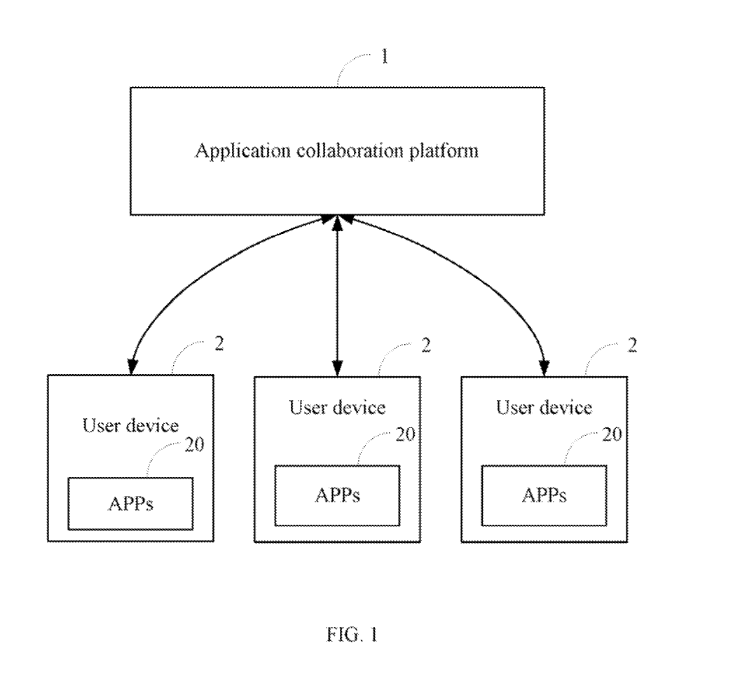

FIG. 1 is a schematic diagram illustrating one embodiment of an application collaboration (AC) platform, 1 which communicates with a plurality of user devices 2. In the embodiment, the AC platform 1 may communicate with each of the user devices 2 via a network, such as a local area network (LAN), an Ethernet network, or the Internet. The AC platform 1 may be, for example, a network server in the Ethernet network or the Internet or a computer in the LAN. Each of the user devices 2 may be, for example, mobile devices (e.g., smart phones or tablet computers), table computers, or other similar devices.

In the illustrated embodiment, each user device 2 is installed with one or more software applications (APPs) 20. Each user device 2 is capable of logging into the AC platform 1 to send an AC request to another user device 2 via the AC platform 1, where the AC request requests the another user device 2 to collaborate in finishing a task of a software application, such as a game task. Hereinafter, the user device 2 which sends the AC request is defined as a request device, and the another user device 2 which receives the AC request is defined as a target device.

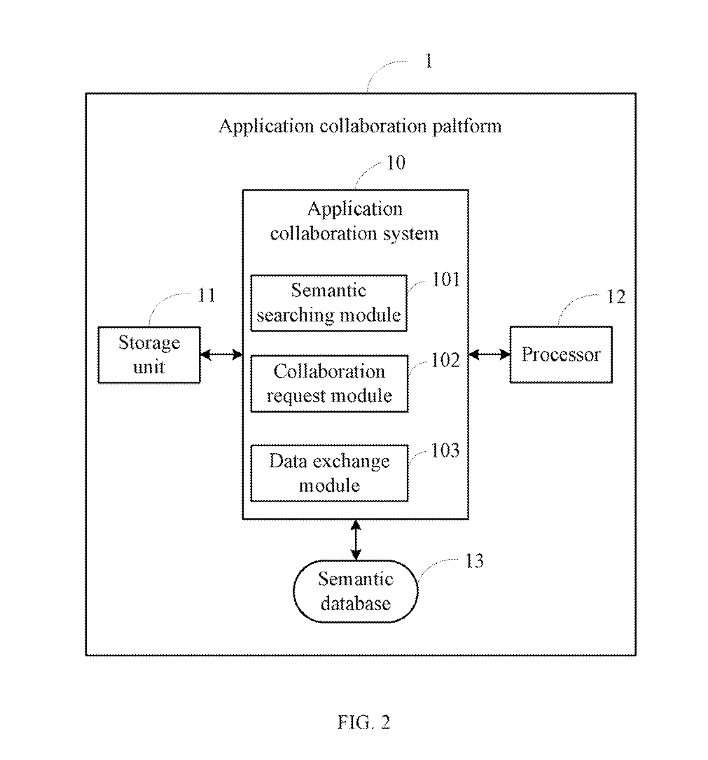

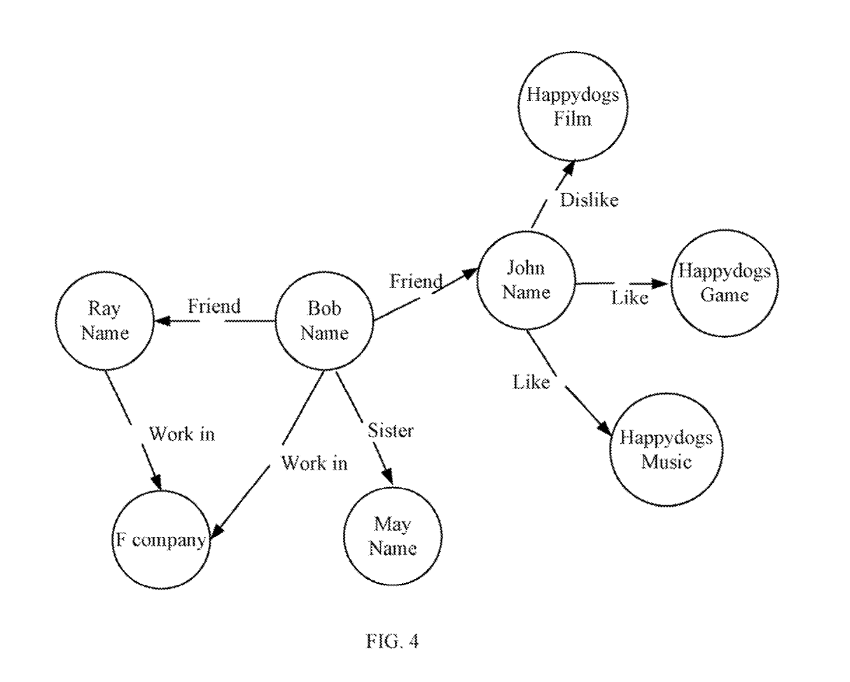

FIG. 2 is a schematic block diagram of the AC platform 1 of FIG. 1. The AC platform 1 includes an AC system 10 comprising a plurality of functional modules, a storage unit 11, a processor 12, and a semantic database 13. The semantic database 13 is also called semantic web, which includes semantic descriptions correlated with each of the user devices 2. The semantic descriptions include relevant information of the user devices 2 which can be recognized by the AC platform 1. For example, as shown in FIG. 4, the semantic database 13 includes relevant information of a user (Bob) of a user device 2. The relevant information of Bob may be, for example, human relationships and personal preferences of Bob. The semantic descriptions of each user device 2 stored in the semantic database 13 can be updated by the user of each user device 2 when the user logins to the AC platform 1 using the corresponding user device 2. Each of the functional modules of the AC system 10 may include a plurality of programs in the form of one or more computerized instructions stored in the storage unit 11 and executed by the processor 12 to perform operations of the customer premise equipment 200. In the embodiment, the call AC system 10 includes a semantic searching module 101, a collaboration request module 102, and a data exchange module 103.

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

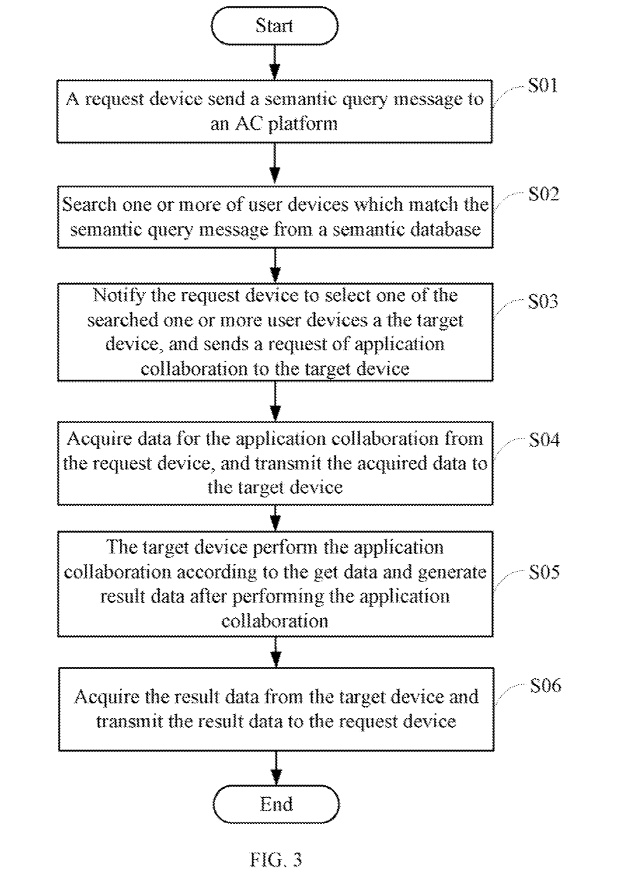

FIG. 3 shows a flowchart of one embodiment of an application collaboration method using the AC system 10 of FIG. 2. Depending on the embodiment, additional steps may be added, others removed, and the ordering of the steps may be changed.

In step S01, the request device (one of the user devices 2) sends a semantic query message to the AC platform 1 to query one or more of the user devices 2 capable of performing application collaboration with the request device. For example, when a user (Bob) plays a “Happydogs” game and cannot accomplish a task for a long time, Bob may send the semantic query message to the AC platform 1 using the request device to request his friend, who likes to play the “Happydogs” game, to help to accomplish this task. Thus, the semantic query message sent by Bob may include keywords of “Bob”, “Friend”, and “Happydogs”, for example.

In step S02, the semantic searching module 101 receives the semantic query message, and searches one or more of the user devices 2 which match the semantic query message from the semantic database 13. In the embodiment, when semantic descriptions of any user device include the keywords of the semantic query message, the user device is determined to match the semantic query message. FIG. 4 shows a semantic descriptions of a user device 2 used by Bob. It is shown that John can help

Bob to accomplish the level of the “Happydogs” game according to the semantic query message sent from Bob. Thus, the user device 2 used by John is searched by the semantic searching module 101, and is determined to be match with the semantic query message. If none of the user devices 2 is searched by the semantic searching module 101, the semantic searching module 101 notifies the user, the procedure ends.

Further, the semantic searching module 101 provides a semantic query interface to guide a user of the request device to edit the semantic query message when the request device logins into the AC platform 1, and generates a semantic query command according to the user edited semantic query message. The semantic query interface is displayed on a display of the request when the request device logins into the AC platform 1.

In step S03, the collaboration request module 102 notifies the request device to select one of the searched one or more user devices 2 as the target device, and sends a request of application collaboration to the target device.

In step S04, when the target device accepts the request of application collaboration, the data exchange module 103 acquires data for the application collaboration (e.g., saved game data of the “Happydogs”) from the request device, and transmits the acquired data to the target device. In the embodiment, the request device may store the data for the application collaboration in its own storage or a preset cloud storage space. In other embodiments, the request device may store the data for the application collaboration in the storage unit 11 of the AC platform 1. Then, the location where the data for the application collaboration is stored, is transmitted to the data exchange module 103. Thus, the data exchange module 103 can acquire the data for the application collaboration from the location where the data is stored.

In other embodiments, the data exchange module 103 may send the location where the data is stored to the target device, and then the target device acquires the data from the location. Further, in order to improve the data security, the data for the application collaboration may be encrypted by the request device when the data is stored in the location and is decrypted by the target device when the data is acquired by the target device.

In step S05, when the data is obtained by the target device, the target device performs the application collaboration according to the obtained data and generates result data after performing the application collaboration. For example, a user of the target device may first activate the “Happydogs” application, and then loads the obtained data to the application to help Bob to accomplish the task of the “Happydogs” application.

In step S06, the data exchange module 103 acquires the result data from the target device and transmits the result data to the request device. Thus, the application collaboration between request device and the target device is finished. In other embodiments, the data exchange module 103 may store the result data in the storage unit 11 of AC platform 1 where the data for the application collaboration is stored, and then notifies the request device to acquire the result data from the AC platform.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An application collaboration method implemented by an application collaboration (AC) platform communicating with a plurality of user devices, the AC platform comprising a semantic database which stores semantic descriptions of each of the user devices, the plurality of user devices comprising a request device and a target device, the request requesting the target device to perform application collaboration, the method comprising:
receiving a semantic query message from the request device;
searching one or more of the user devices which match the semantic query message from the semantic database;
notifying the request device to select one of the searched one or more user devices as the target device, and sending a request of the application collaboration to the target device; and
acquiring data for the application collaboration from the request device, and transmitting the acquired data to the target device, wherein the target device performs the application collaboration according to the transmitted data.

2. The method according to claim 1, further comprising:
acquiring from the target device result data generated by the target device after performing the application collaboration and transmitting the result data to the request device.

3. The method according to claim 1, wherein the semantic query message is edited by a user of the request device when the user logins to the AC platform using the request device.

4. The method according to claim 4, further comprising:
providing a semantic query interface used to edit the semantic query message.

5. The method according to claim 1, wherein the data for application collaboration is stored in the request device or in the AC platform.

6. The method according to claim 5, wherein the data for the application collaboration is encrypted by the request device when the data is stored and is decrypted by the target device when the data is acquired by the target device.

7. The method according to claim 1, further comprising:
storing the result data in the AC platform, and notifying the request device to acquire the result data from the AC platform.

8. The method according to claim 1, wherein the AC platform is a network server, and the user devices are mobile devices or table computers.

9. An application collaboration (AC) platform communicating with a plurality of user devices, the plurality of user devices comprising a request device and a target device, the request requesting the target device to perform application collaboration, the AC platform comprising:
a semantic database storing semantic descriptions of each of the user devices;
a processor;
a storage unit;
one or more programs stored in the storage unit and executed by the processor to perform a method of:
receiving a semantic query message from the request device;
searching one or more of the user devices which match the semantic query message from the semantic database;
notifying the request device to select one of the searched one or more user devices as the target device, and sending a request of the application collaboration to the target device; and
acquiring data for the application collaboration from the request device, and transmitting the acquired data to the target device, wherein the target device performs the application collaboration according to the transmitted data.

10. The AC platform according to claim 9, wherein the method further comprises:
acquiring from the target device result data generated by the target device after performing the application collaboration and transmitting the result data to the request device.

11. The AC platform according to claim 9, wherein the semantic query message is edited by a user of the request device when the user logins to the AC platform using the request device.

12. The AC platform according to claim 11, wherein the method further comprising:
providing a semantic query interface used to edit the semantic query message.

13. The AC platform according to claim 9, wherein the data for application collaboration is stored in the request device or in the storage unit of the AC platform.

14. The AC platform according to claim 13, wherein the data for the application collaboration is encrypted by the request device when the data is stored and is decrypted by the target device when the data is acquired by the target device.

15. The AC platform according to claim 9, wherein the method further comprises:
storing the result data in the storage unit of the AC platform, and notifying the request device to acquire the result data from the storage unit of the AC platform.

16. The AC platform according to claim 9, wherein the AC platform is a network server, and the user devices are mobile devices or table computers.
